(19) United States
(12) Patent Application Publication
(10) Pub. No.: US 2024/0132069 A1
(43) Pub. Date: Apr. 25, 2024

(54) VEHICLE MOVING APPARATUS

(71) Applicant: Toyota Jidosha Kabushiki Kaisha, Toyota-shi (JP)

(72) Inventor: Hideki KAMATANI, Nagoya-shi (JP)

(73) Assignee: Toyota Jidosha Kabushiki Kaisha, Toyota-shi (JP)

(21) Appl. No.: 18/358,477

(22) Filed: Jul. 24, 2023

(30) Foreign Application Priority Data
Oct. 23, 2022 (JP) 2022-169773

(51) Int. Cl. B60W 30/16

(52) U.S. Cl. CPC B60W 30/162; B60W 2554/80; B60W 2720/106

(57) ABSTRACT

A vehicle moving apparatus stops executing an autonomous acceleration/deceleration control and executes a control to autonomously control an acceleration and a deceleration of an own vehicle so as to maintain a distance between the own vehicle and a preceding vehicle when there is a following vehicle, and a distance between the preceding vehicle and the following vehicle becomes equal to or smaller than a predetermined distance while the autonomous acceleration/deceleration control is executed.

### CROSS-REFERENCE TO RELATED APPLICATIONS

This application claims priority to Japanese patent application No. JP 2022-169773 filed on Oct. 24, 2022, the content of which is hereby incorporated by reference in its entirety.

### BACKGROUND

### Field

The present invention relates to a vehicle moving apparatus.

### Description of the Related Art

There is known a vehicle moving apparatus which executes a following moving control to cause an own vehicle to move so as to follow a preceding vehicle. In addition, there is also known a vehicle moving apparatus which executes an autonomous acceleration/deceleration control to cause the own vehicle to coast when the own vehicle is required to be decelerated in order to reduce an amount of energy consumed for moving an own vehicle (for example, see JP 4677945 B).

When the own vehicle is caused to coast or is accelerated, preventing the own vehicle from being too close to the preceding vehicle or a following vehicle when a distance between the preceding vehicle and the following vehicle is shortened while the above-described autonomous acceleration/deceleration control is executed, a coasting and an acceleration of the own vehicle are frequently switched. Thereby, the amount of energy consumed by the own vehicle may be increased.

### SUMMARY

An object of the present invention is to provide a vehicle moving apparatus which can prevent the amount of energy consumed for moving the own vehicle from being increased when the distance between the preceding vehicle and the following vehicle is shortened while the autonomous acceleration/deceleration control is executed.

According to the present invention, a vehicle moving apparatus comprises an electronic control unit configured to execute an autonomous acceleration/deceleration control to autonomously control an acceleration and a deceleration of an own vehicle so as to control a distance between the own vehicle and a preceding vehicle within a predetermined preceding inter-vehicle distance range by (i) starting to execute a coasting control to cause the own vehicle to coast when the distance between the own vehicle and the preceding vehicle decreases and reaches a lower limit value of the predetermined preceding inter-vehicle distance range and (ii) starting to execute an acceleration control to accelerate the own vehicle when the distance between the own vehicle and the preceding vehicle increases and reaches an upper limit value of the predetermined preceding inter-vehicle distance range.

The electronic control unit is configured to (i) stop executing the autonomous acceleration/deceleration control and (ii) execute a control to autonomously control the acceleration and the deceleration of the own vehicle so as to maintain the distance between the own vehicle and the preceding vehicle when there is a following vehicle, and a distance between the preceding vehicle and the following vehicle becomes equal to or smaller than a predetermined distance while the autonomous acceleration/deceleration control is executed.

When there is the following vehicle while the autonomous acceleration/deceleration control is executed, it is not preferred that the own vehicle is too close to the following vehicle. On the other hand, when (i) there is the following vehicle, (ii) the own vehicle is caused to coast or is accelerated, preventing the own vehicle from being too close to the following vehicle, based on the distance between the own vehicle and the preceding vehicle, and (iii) the distance between the preceding vehicle and the following vehicle is shortened, executions of the coasting control and the acceleration control are frequently switched. Thereby, the amount of energy consumed for moving the own vehicle may be increased.

With the present invention, when the distance between the preceding vehicle and the following vehicle becomes equal to or smaller than the predetermined distance, the control to autonomously control the acceleration and the deceleration of the own vehicle is executed such that the distance between the own vehicle and the preceding vehicle is maintained at the target distance instead of the autonomous acceleration and deceleration control. Therefore, the amount of energy consumed for moving the own vehicle can be prevented from being increased when the distance between the preceding vehicle and the following vehicle is shortened while the autonomous acceleration/deceleration control is executed.

According to an aspect of the present invention, the electronic control unit may be configured to (i) start to execute the acceleration control when there is the following vehicle, and the distance between the own vehicle and the following vehicle decreases and reaches a lower limit value of a predetermined following inter-vehicle distance range while the autonomous acceleration/deceleration control and then, (ii) terminate executing the acceleration control when the distance between the own vehicle and the following vehicle increases and reaches an upper limit value of the predetermined following inter-vehicle distance range.

With this aspect of the present invention, the own vehicle is accelerated when the distance between the own vehicle and the following vehicle becomes short. Therefore, a moving safety of the own vehicle can be ensured.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle moving apparatus according to an embodiment of the present invention.

FIG. 2A is a view which shows a scene that there is a preceding vehicle ahead of an own vehicle, and there is a following vehicle behind the own vehicle.

FIG. 2B is a view which shows a scene that there is no preceding vehicle ahead of the own vehicle, and there is the following vehicle behind the own vehicle.

FIG. 3 is a view which shows a flowchart of a routine executed by the vehicle moving apparatus according to the embodiment of the present invention.

FIG. 4 is a view which shows a flowchart of a routine executed by the vehicle driving apparatus according to the embodiment of the present invention.

### DESCRIPTION OF THE EMBODIMENTS

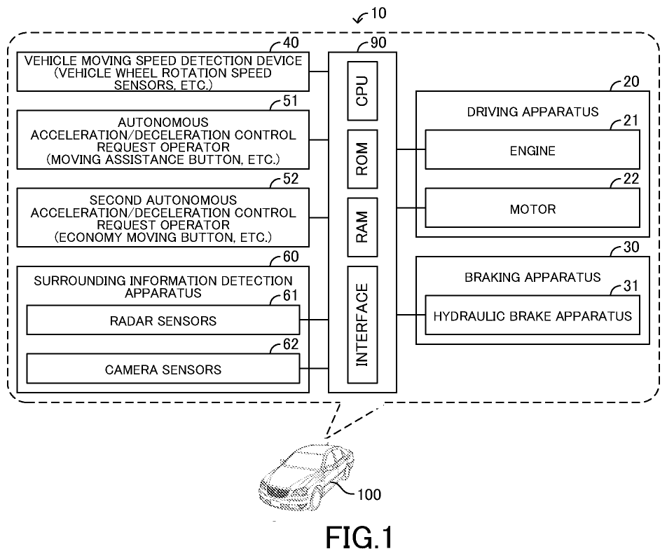

Below, a vehicle moving apparatus according to an embodiment of the present invention will be described with reference to the drawings. As shown in FIG. 1, the vehicle moving apparatus 10 according to the embodiment of the present invention is mounted on an own vehicle 100. Hereinafter, the vehicle moving apparatus 10 will be described by exemplifying that an operator of the own vehicle 100 is a driver of the own vehicle 100, i.e., a person who rides on the own vehicle 100 and drives the own vehicle 100.

However, the operator of the own vehicle 100 may be a remote operator of the own vehicle 100, i.e., an operator who is not in the own vehicle 100 but remotely drives the own vehicle 100. When the operator of the own vehicle 100 is the remote operator, the vehicle moving apparatus 10 is mounted on the own vehicle 100 and a remote control facility installed outside the own vehicle 100 for remotely driving the own vehicle 100, respectively and functions of the vehicle moving apparatus 10 described below are realized by the vehicle moving apparatus 10 mounted on the own vehicle 100 and the vehicle moving apparatus 10 mounted on the remote control facility.

The vehicle moving apparatus 10 includes an ECU (an electronic control device) 90. The ECU 90 includes a microcomputer as a main component. The microcomputer includes a CPU, a ROM, a RAM, a non-volatile memory, and an interface. The CPU realizes various functions by executing instructions, programs, or routines stored in the ROM. In the present embodiment, the vehicle moving apparatus 10 includes one ECU, but a plurality of ECUs may be provided, and various processes described later may be executed by the ECUs.

The vehicle moving apparatus 10 executes an autonomous acceleration/deceleration control as an autonomous driving control or an automatic driving control. The autonomous acceleration/deceleration control is a control to cause the own vehicle 100 to move by autonomously controlling activations of a driving apparatus 20 and a braking apparatus 30 to accelerate or decelerate the own vehicle 100. In the present embodiment, the autonomous acceleration/deceleration control includes an inter-vehicle distance control and a moving speed control. Further, in the present embodiment, the driving apparatus 20 includes an internal combustion engine 21 and an electric motor 22, and the braking apparatus 30 includes a hydraulic brake apparatus 31.

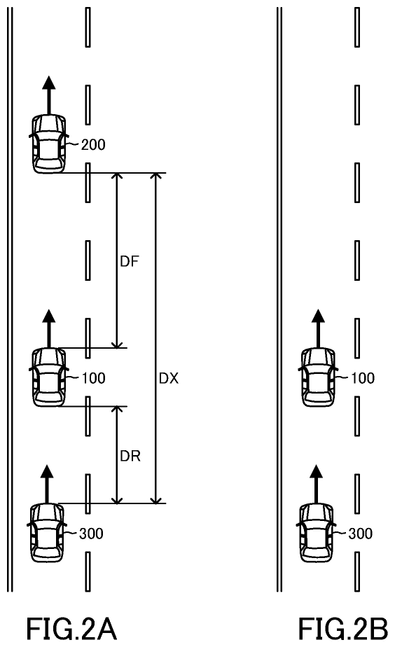

The inter-vehicle distance control is the autonomous acceleration/deceleration control executed when there is a preceding vehicle 200 ahead of the own vehicle 100 as shown in FIG. 2A. In other words, the inter-vehicle distance control is a control to autonomously accelerate or decelerate the own vehicle 100, based on a target preceding vehicle distance DFtgt.

The preceding vehicle 200 is another vehicle which moves ahead of the own vehicle 100 within a predetermined distance (or a preceding vehicle determination distance DFth) from the own vehicle 100. The vehicle moving apparatus 10 detects the preceding vehicle 200, based on surrounding detection information IS described later.

The target preceding inter-vehicle distance DFtgt is a preceding inter-vehicle distance DF set by the driver as a control target used by the inter-vehicle distance control. The preceding inter-vehicle distance DF is a distance between the own vehicle 100 and the preceding vehicle 200. The vehicle moving apparatus 10 acquires the preceding inter-vehicle distance DF, based on the surrounding detection information IS described later.

On the other hand, the moving speed control is the autonomous acceleration/deceleration control executed when there is no preceding vehicle 200 ahead of the own vehicle 100 as shown in FIG. 2B. In other words, the moving speed control is a control to autonomously accelerate or decelerate the own vehicle 100, based on a set speed Vset. The set speed Vset is a moving speed of the own vehicle 100 (or an own vehicle moving speed Vego) set by the driver as a control target used by the moving speed control. It should be noted that the vehicle moving apparatus 10 acquires the own vehicle moving speed Vego by a vehicle moving speed detection device 40.

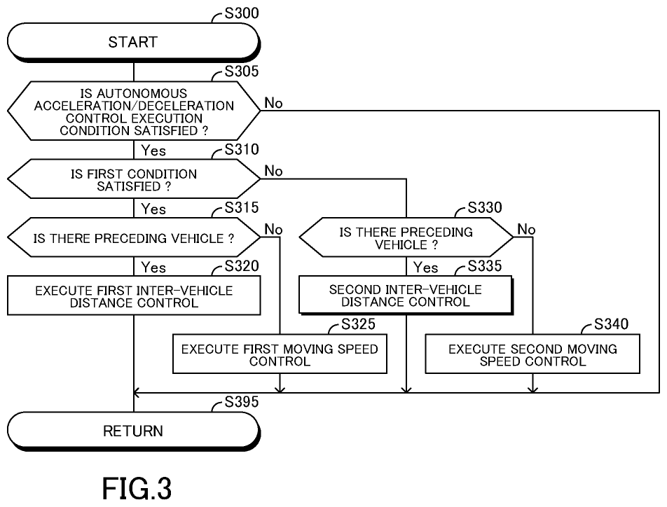

Next, operations of the vehicle moving apparatus 10 will be described in more detail. The vehicle moving apparatus 10 executes a routine shown in FIG. 3 with a predetermined calculation cycle. When the vehicle moving apparatus 10 starts a process from a step S300 of the routine shown in FIG. 3, the vehicle moving apparatus 10 proceeds with the process to a step S305 to determine whether an autonomous acceleration/deceleration control execution condition C0 is satisfied. The autonomous acceleration/deceleration control execution condition C0 is a condition that the autonomous acceleration/deceleration control is requested to be executed. The driver can request the vehicle moving apparatus 10 to execute the autonomous acceleration/deceleration control by operating an autonomous acceleration/deceleration control request operator 51 such as a moving assistance button.

When the vehicle moving apparatus 10 determines “Yes” at the step S305, the vehicle moving apparatus 10 proceeds with the process to a step S310 to determine whether a first condition C1 is satisfied. The first condition C1 is a condition that a second autonomous acceleration/deceleration control (or an economy moving control) is not requested to be executed. The driver can request the vehicle moving apparatus 10 to execute the second autonomous acceleration/deceleration control by operating a second autonomous acceleration/deceleration control request operator 52 such as an economy moving button. Further, in the present embodiment, the second autonomous acceleration/deceleration control includes a second inter-vehicle distance control and a second moving speed control described later.

When the vehicle moving apparatus 10 determines “Yes” at the step S310, the vehicle moving apparatus 10 proceeds with the process to a step S315 to determine whether there is the preceding vehicle 200. The vehicle moving apparatus 10 determines whether there is the preceding vehicle 200, based on the surrounding detection information IS.

The surrounding detection information IS is information provided from a surrounding information detection apparatus 60. In the present embodiment, the surrounding information detection apparatus 60 includes radar sensors 61 and camera sensors 62. The surrounding information detection apparatus 60 provides the vehicle moving apparatus 10 with radar detection information, i.e., information on situations around the own vehicle 100 acquired by the radar sensors 61 as the surrounding detection information IS. In addition, the surrounding information detection apparatus 60 provides the vehicle moving apparatus 10 with image information, i.e., image data on views around the own vehicle 100 acquired by the camera sensors 62 as the surrounding detection information IS.

When the vehicle moving apparatus 10 determines “Yes” at the step S315, the vehicle moving apparatus 10 proceeds with the process to a step S320 to execute a first inter-vehicle distance control. Then, the vehicle moving apparatus 10 proceeds with the process to a step S395 to terminate executing this routine once.

The first inter-vehicle distance control is a control to maintain the preceding inter-vehicle distance DF at the target preceding inter-vehicle distance DFtgt. In other words, the first inter-vehicle distance control is included in a first autonomous acceleration/deceleration control. In particular, the first inter-vehicle distance control is a control to autonomously control the activations of the driving apparatus 20 and the braking apparatus 30 to accelerate or decelerate the own vehicle 100 such that the preceding inter-vehicle distance DF is maintained at the target preceding inter-vehicle distance DFtgt. Therefore, the first inter-vehicle distance control is a so-called following moving control or an adaptive cruise control.

On the other hand, when the vehicle moving apparatus 10 determines “No” at the step S315, the vehicle moving apparatus 10 proceeds with the process to a step S325 to execute a first moving speed control. Then, the vehicle moving apparatus 10 proceeds with the process to the step S395 to terminate executing this routine once.

The first moving speed control is a control to maintain the own vehicle moving speed Vego at the set speed Vset. In the present embodiment, the first moving speed control is included in the first autonomous acceleration/deceleration control. In particular, the first moving speed control is the autonomous acceleration/deceleration control to autonomously control the activations of the driving apparatus 20 and the braking apparatus 30 to accelerate or decelerate the own vehicle 100 such that the own vehicle moving speed Vego is maintained at the set speed Vset. Therefore, the first moving speed control is a so-called constant speed moving control or a cruise control.

When the vehicle moving apparatus 10 determines “No” at the step S310, the vehicle moving apparatus 10 proceeds with the process to a step S330 to determine whether there is the preceding vehicle 200. That is, when the first condition C1 is not satisfied at the step S310 and therefore, a second condition C2 that the second autonomous acceleration/deceleration control (or the economy moving control) is requested to be executed, is satisfied, the vehicle moving apparatus 10 proceeds with the process to the step S330 to determine whether there is the preceding vehicle 200.

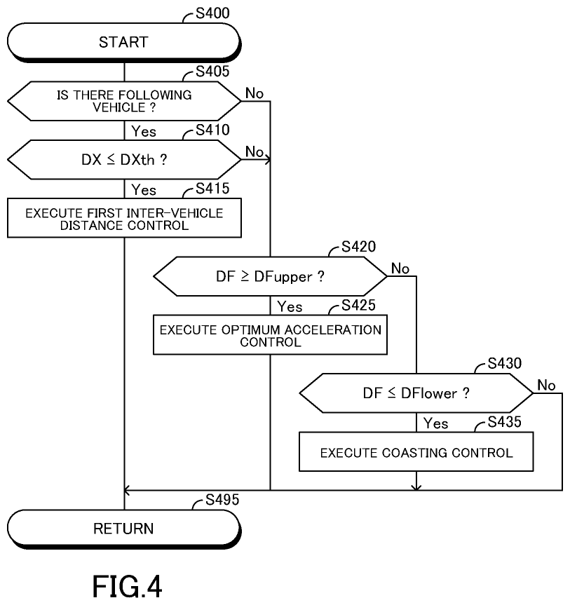

When the vehicle moving apparatus 10 determines “Yes” at the step S330, the vehicle moving apparatus 10 proceeds with the process to a step S335 to execute the second inter-vehicle distance control by executing a routine shown in FIG. 4 as will be described later. Then, the vehicle moving apparatus 10 proceeds with the process to the step S395 to terminate executing this routine once.

In general, the second inter-vehicle distance control is the autonomous acceleration/deceleration control to autonomously accelerate or decelerate the own vehicle 100 so as to control the distance between the own vehicle 100 and the preceding vehicle 200 (i.e., the preceding inter-vehicle distance DF) within a predetermined distance range (or a predetermined preceding inter-vehicle distance range Rd) by (i) starting to execute a coasting control to cause the own vehicle 100 to coast when the distance between the own vehicle 100 and the preceding vehicle 200 (i.e., the preceding inter-vehicle distance DF) increases and reaches a forward upper limit distance DFupper, i.e., an upper limit value of the predetermined preceding inter-vehicle distance range Rd and (ii) starting to execute an acceleration control (or an optimum acceleration control) to accelerate the own vehicle 100 when the distance between the own vehicle 100 and the preceding vehicle 200 (i.e., the preceding inter-vehicle distance DF) decreases and reaches a forward lower limit distance DFlower, i.e., a lower limit value of the predetermined preceding inter-vehicle distance range Rd,

In other words, the second inter-vehicle distance control is generally a control to maintain the preceding inter-vehicle distance DF within the predetermined preceding inter-vehicle distance range Rd including the target preceding inter-vehicle distance DFtgt. Further, in other words, the second inter-vehicle distance control is a control to execute (i) the optimum acceleration control when the preceding inter-vehicle distance DF increases and reaches the forward upper limit distance DFupper, i.e., the upper limit value of the predetermined preceding inter-vehicle distance range Rd and (ii) execute the coasting control when the preceding inter-vehicle distance DF decreases and reaches the forward lower limit distance DFlower, i.e., the lower limit value of the predetermined preceding inter-vehicle distance range Rd.

The second inter-vehicle distance control may be configured to control starting and terminating the optimum acceleration control, based on a distance between the following vehicle 300 and the own vehicle 100 (or a following inter-vehicle distance DR) in addition to controlling starting the optimum acceleration control and the coasting control, based on the preceding inter-vehicle distance DF as described above.

In this case, the vehicle moving apparatus 10 is configured to (i) start to execute the optimum acceleration control when the following inter-vehicle distance DR decreases and reaches a rearward lower limit distance DRlower, i.e., a lower limit value of a predetermined distance range (or a predetermined following inter-vehicle distance range) and then, (ii) permit terminating executing the optimum acceleration control when the following inter-vehicle distance DR increases and reaches a rearward upper limit distance DRupper, i.e., an upper limit value of the predetermined following inter-vehicle distance range. In addition, in this case, the vehicle moving apparatus 10 may be configured to start to execute the coasting control when the vehicle moving apparatus 10 permits to terminate executing the optimum acceleration control, or may be configured to continue executing the optimum acceleration control when the vehicle moving apparatus 10 permits to terminate executing the optimum acceleration control, and the preceding inter-vehicle distance DF is smaller than the forward lower limit distance DFlower. In this case, when the preceding inter-vehicle distance DF reaches the forward lower limit distance DFlower before the vehicle moving apparatus 10 permits to terminate executing the optimum acceleration control, the vehicle moving apparatus 10 terminates executing the optimum acceleration control and starts to execute the coasting control.

It should be noted that the following vehicle 300 is another vehicle which moves behind the own vehicle 100 within a predetermined distance (or a following vehicle determination distance DRth) from the own vehicle 100. The vehicle moving apparatus 10 detects the following vehicle 300, based on the surrounding detection information IS.

On the other hand, when the vehicle moving apparatus 10 determines “No” at the step S330, the vehicle moving apparatus 10 proceeds with the process to a step S340 to execute the second moving speed control. Then, the vehicle moving apparatus 10 proceeds with the process to the step S395 to terminate executing this routine once.

The second moving speed control is a control to maintain the own vehicle moving speed Vego within a predetermined speed range Rv including the set speed Vset. In other words, the second moving speed control is a control to (i) control the activation of the driving apparatus 20 to accelerate the own vehicle 100 when the own vehicle moving speed Vego decreases and reaches a lower limit speed Vlower, i.e., a lower limit value of the predetermined speed range Rv and (ii) control the activation of the driving apparatus 20 to decelerate the own vehicle 100 when the own vehicle moving speed Vego increases and reaches an upper limit speed Vupper, i.e., an upper limit value of the predetermined speed range Rv.

In particular, the second moving speed control is a control to (i) accelerate the own vehicle 100 by executing the optimum acceleration control when the own vehicle moving speed Vego decreases and reaches the lower limit speed Vlower and (ii) decelerate the own vehicle 100 by executing the coasting control when the own vehicle moving speed Vego increases and reaches the upper limit speed Vupper.

The optimum acceleration control is a control to control the activation of the driving apparatus 20 such that power is output from the driving apparatus 20 with the highest energy efficiency. In particular, the optimum acceleration control is a control to operate the internal combustion engine 21 at an optimum operating point (or an operating point near the optimum operating point).

On the other hand, the coasting control is a control to control the activation of the driving apparatus 20 such that the own vehicle 100 coasts.

Further, when the vehicle moving apparatus 10 determines “No” at the step S305, the vehicle moving apparatus 10 proceeds with the process directly to the step S395 to terminate executing this routine once.

Next, the routine shown in FIG. 4 will be described. When the vehicle moving apparatus 10 proceeds with the process to the step S335 of the routine shown in FIG. 3, the vehicle moving apparatus starts a process from a step S400 of the routine shown in FIG. 4 and proceeds with the process to a step S405 to determine whether there is the following vehicle 300.

When the vehicle moving apparatus 10 determines “Yes” at a step S405, the vehicle moving apparatus 10 proceeds with the process to a step S410 to determines whether a forward-rearward inter-vehicle distance DX is equal to or smaller than a predetermined distance (or a predetermined forward-rearward inter-vehicle distance DXth).

The forward-rearward inter-vehicle distance DX is a distance between the preceding vehicle 200 and the following vehicle 300 and is acquired, based on the surrounding detection information IS. Further, the predetermined forward-rearward inter-vehicle distance DXth may be appropriately set so as to ensure a moving safety of the own vehicle 100. For example, the predetermined forward-rearward inter-vehicle distance DXth is set to be greater than a sum of the rearward upper limit distance DRupper and the forward lower limit distance DFlower when the second inter-vehicle distance control is configured to (i) start to execute the optimum acceleration control when the following inter-vehicle distance DR decreases and reaches the rearward lower limit distance DRlower and (ii) start to execute the coasting control when the following inter-vehicle distance DR increases and reaches the rearward upper limit distance DRupper greater than the rearward lower limit distance DRlower.

When the vehicle moving apparatus 10 determines “Yes” at the step S410, the vehicle moving apparatus 10 proceeds with the process to a step S415 to execute the first inter-vehicle distance control. Then, the vehicle moving apparatus 10 proceeds with the process to a step S495 to terminate executing this routine once.

On the other hand, when the vehicle moving apparatus 10 determines “No” at the step S410, the vehicle moving apparatus 10 proceeds with the process to a step S420. Also, the vehicle moving apparatus 10 proceeds with the process to the step S420 when the vehicle moving apparatus determines “No” at the step S405.

When the vehicle moving apparatus 10 proceeds with the process to the step S420, the vehicle moving apparatus 10 determines whether the preceding inter-vehicle distance DF is equal to or greater than the forward upper limit distance DFupper. When the vehicle moving apparatus 10 determines “Yes” at the step S420, the vehicle moving apparatus 10 proceeds with the process to a step S425 to execute the optimum acceleration control. Then, the vehicle moving apparatus 10 proceeds with the process to the step S495 to terminate executing this routine once.

On the other hand, when the vehicle moving apparatus 10 determines “No” at the step S420, the vehicle moving apparatus 10 proceeds with the process to a step S430 to determine whether the preceding inter-vehicle distance DF is equal to or smaller than the forward lower limit distance DFlower. When the vehicle moving apparatus 10 determines “Yes” at the step S430, the vehicle moving apparatus 10 proceeds with the process to a step S435 to execute the coasting control. Then, the vehicle moving apparatus 10 proceeds with the process to step S495 to terminate executing this routine once.

On the other hand, when the vehicle moving apparatus 10 determines “No” at the step S430, the vehicle moving apparatus 10 proceeds with the process directly to the step S495 to terminate executing this routine once.

The operations of the vehicle moving apparatus 10 have been described.

### Advantages

When there is the following vehicle 300 while the second inter-vehicle distance control is executed, it is not preferred that the own vehicle 100 is too close to the following vehicle 300. On the other hand, when the own vehicle 100 is caused to coast or is accelerated, based on the preceding inter-vehicle distance DF, preventing the own vehicle 100 from being too close to the following vehicle 300 when there is the following vehicle 300, and the forward-rearward inter-vehicle distance DX is shortened, the executions of the coasting control and the optimum acceleration control are frequently switched. Thereby, the amount of energy consumed for moving the own vehicle 100 may be increased.

With the vehicle moving apparatus 10, when the forward-rearward inter-vehicle distance DX becomes equal to or smaller than the predetermined forward-rearward inter-vehicle distance DXth, the first inter-vehicle distance control is executed instead of the second inter-vehicle distance control. Therefore, the amount of energy consumed for moving the own vehicle 100 can be prevented from being increased when the forward-rearward inter-vehicle vehicle distance DX is shortened while the second inter-vehicle distance control is executed.

It should be noted that the invention is not limited to the aforementioned embodiments, and various modifications can be employed within the scope of the invention.

What is claimed is:

1. A vehicle moving apparatus, comprising an electronic control unit configured to execute an autonomous acceleration/deceleration control to autonomously control an acceleration and a deceleration of an own vehicle so as to control a distance between the own vehicle and a preceding vehicle within a predetermined preceding inter-vehicle distance range by (i) starting to execute a coasting control to cause the own vehicle to coast when the distance between the own vehicle and the preceding vehicle decreases and reaches a lower limit value of the predetermined preceding inter-vehicle distance range and (ii) starting to execute an acceleration control to accelerate the own vehicle when the distance between the own vehicle and the preceding vehicle increases and reaches an upper limit value of the predetermined preceding inter-vehicle distance range,
wherein the electronic control unit is configured to (i) stop executing the autonomous acceleration/deceleration control and (ii) execute a control to autonomously control the acceleration and the deceleration of the own vehicle so as to maintain the distance between the own vehicle and the preceding vehicle when there is a following vehicle, and a distance between the preceding vehicle and the following vehicle becomes equal to or smaller than a predetermined distance while the autonomous acceleration/deceleration control is executed.

2. The vehicle moving apparatus as set forth in claim 1, wherein the electronic control unit is configured to (i) start to execute the acceleration control when there is the following vehicle, and the distance between the own vehicle and the following vehicle decreases and reaches a lower limit value of a predetermined following inter-vehicle distance range while the autonomous acceleration/deceleration control is executed and then, (ii) terminate executing the acceleration control when the distance between the own vehicle and the following vehicle increases and reaches an upper limit value of the predetermined following inter-vehicle distance range.
